(19) United States
(12) Patent Application Publication
(10) Pub. No.: US 2015/0269649 A1
(43) Pub. Date: Sep. 24, 2015

(54) Shopping Tool

(71) Applicants: James William Shoemaker, Dexter, IA (US); Mark Joseph Hoag, II, West Des Moines, IA (US)

(72) Inventors: James William Shoemaker, Dexter, IA (US); Mark Joseph Hoag, II, West Des Moines, IA (US)

(21) Appl. No.: 14/213,110

(22) Filed: Mar. 14, 2014

Related U.S. Application Data
(60) Provisional application No. 61/791,373, filed on Mar. 15, 2013.

(51) Int. Cl. G06Q 30/06

(52) U.S. Cl. CPC G06Q 30/0633

(57) ABSTRACT

The shopping tool employs a shopping list generator that uses an inventory management module, user input, or a recipe module to generate a shopping list. A list organizer uses a store selection and its associated store layout comprising locations of food items to order the list relative to the items' locations in the store. The organizer may take into account the shopper's past shopping pattern in the selected store when ordering the items on the list. Selection from the recipe module results in populating the ingredients on the list. A warning system is also provided to identify warned food items, and provide substitute suggestions.

### FIELD OF THE INVENTION

The present invention relates to a tool and method for managing the tasks of grocery shopping by determining nutritional values related to shopping list items, reordering shopping items in the order the individual shops within a specific store, automatically adding shopping list items based previous purchase habits, and maintaining a running inventory of items in the user's storage pantry.

### BACKGROUND OF THE INVENTION

Most adults are tasked with grocery shopping at some point in their lives. Many sit down and make the proverbial list before going to the store. The list making task typically includes a combination of thinking ahead or perhaps actual menu planning and determining which items are needed by checking the pantry and refrigerator in the home. As if this task is not daunting enough, the present emphasis on heart healthy diets, and healthy weight and the ever growing body of knowledge of how certain foods and nutrition can effect a variety of health metrics also drives the grocery purchases and, in turn, the grocery lists themselves. Balancing nutritional needs and goals with meal planning begins with managing the pantry inventory by careful grocery shopping and, more often than not, is accomplished through use of the grocery list.

It is possible to use one of several means to create a grocery list beginning with the basic and age-old paper list. It is also quite possible and useful to make a “master list” of all items purchased, ever, and then simply select items from the master list, either on hard copy or via electronic means. Some of the most organized shoppers may even keep a running list of items removed from their pantries so as to reduce their efforts for creating a shopping list. And those shoppers wishing to make the actual shopping trip more efficient will shop regularly at the same store and organize the grocery list in an order that reflects the organization and layout of the store so as to work through aisles, starting at one side of the store, and pick up the items in order on the list which reflects the order in the store. However, none of these methods automates, in any way, the addition to the list of new items needed for a particular recipe. Nor does the list account for or acknowledge the fact that a shopper may elect to shop at a different store and the need to re-order the list to correspond with the different store's layout. Further, a list is unlikely to track, or detect items that include nutritional values that a particular shopper may need to avoid e.g. allergens, high sodium, certain food dyes, etc. And, the list is unlikely to take into account the nutritional values of the items themselves, or of the differences in nutritional values of a food item based on the brand name on the item.

### SUMMARY OF THE INVENTION

The present invention provides a tool that creates a grocery list which is ordered according to the lay out of the store in which the list will be used and according to the shopping pattern of the specific shopper; maintains a running inventory of products on hand; analyzes the nutritional profile of each item on the list and warns the user of any nutritional characteristic of an item that the user has logged as undesirable; suggest items that are due for purchase based on previous purchase history.

### BRIEF DESCRIPTION OF THE DRAWINGS

FIGS. 1 and 2 are flow charts showing data flow;

FIG. 3 is an example of a shopping list generated by the shopping tool of the invention;

FIG. 4 is an example of a list of stores from which to select;

FIG. 5 is an example of a partial inventory list;

FIG. 6 is an example of a shopping list organized according to the lay out of the selected store;

FIG. 7 is an example of nutritional value information; and

FIG. 8 is an example of a shopping list showing symbols indicating warning status.

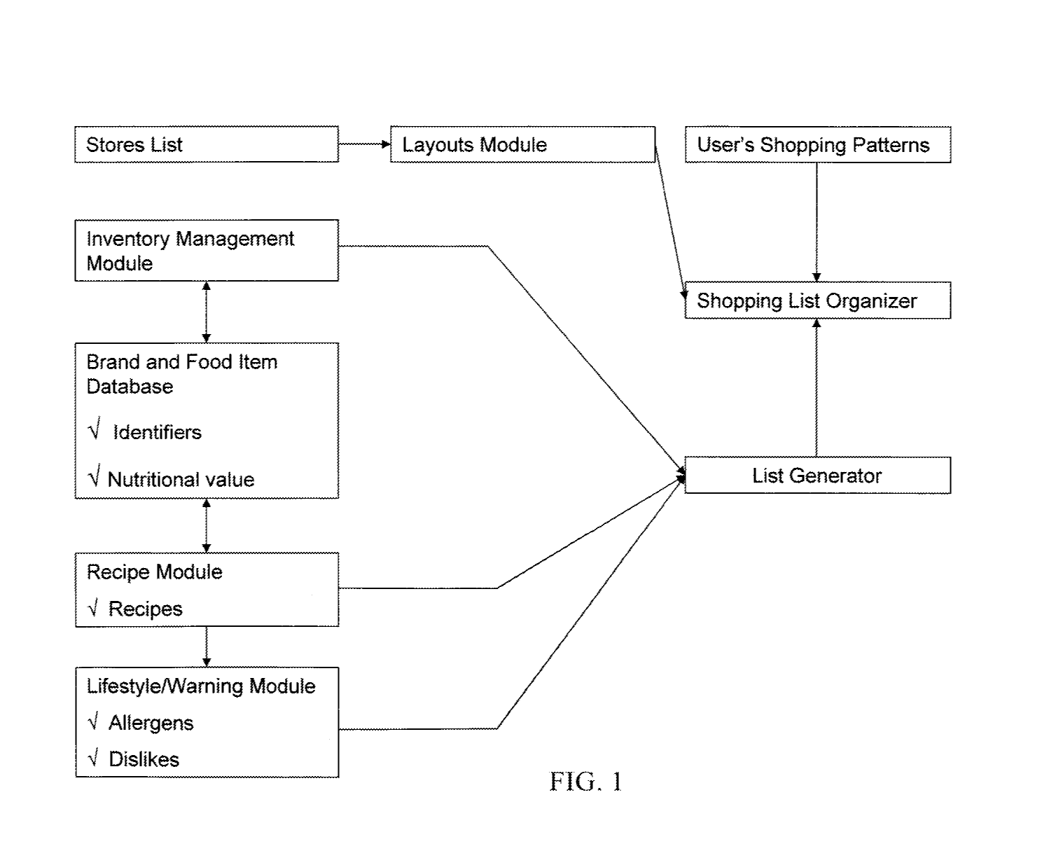

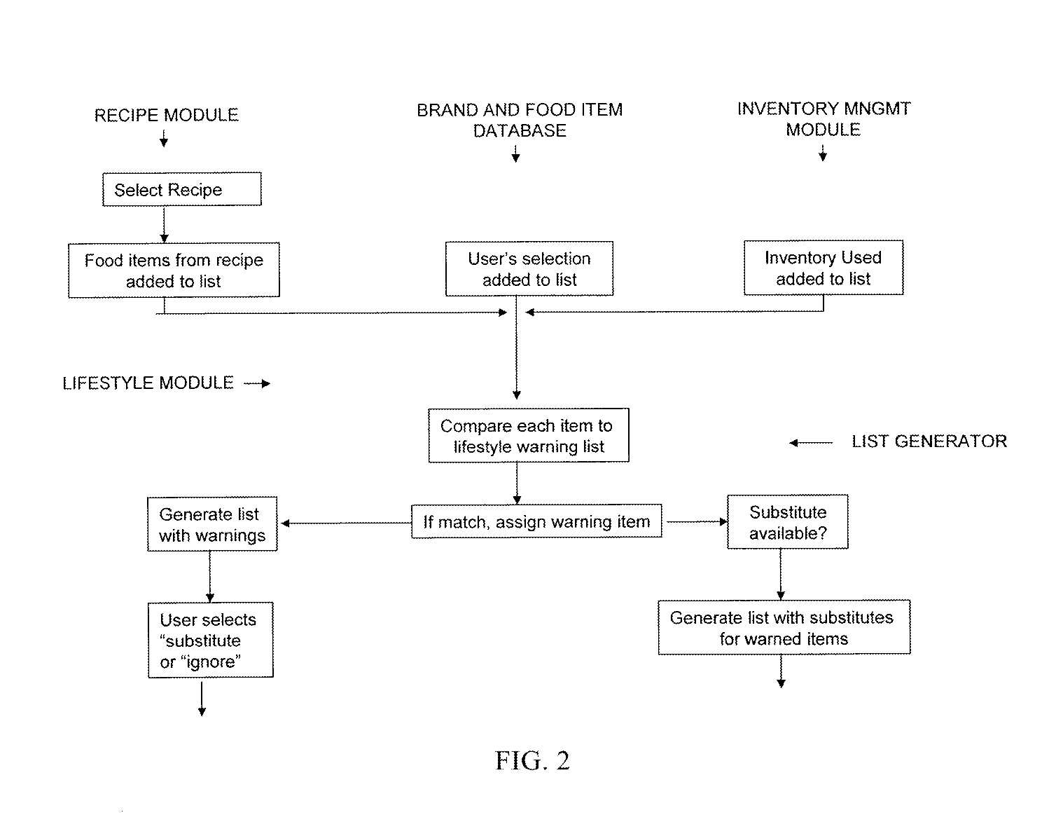

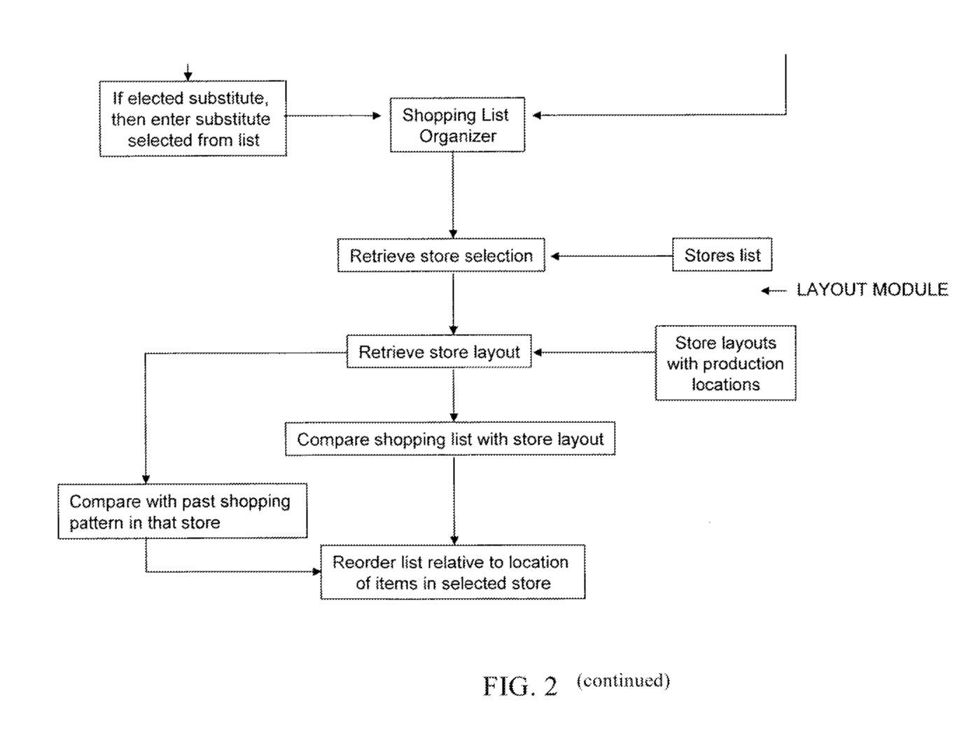

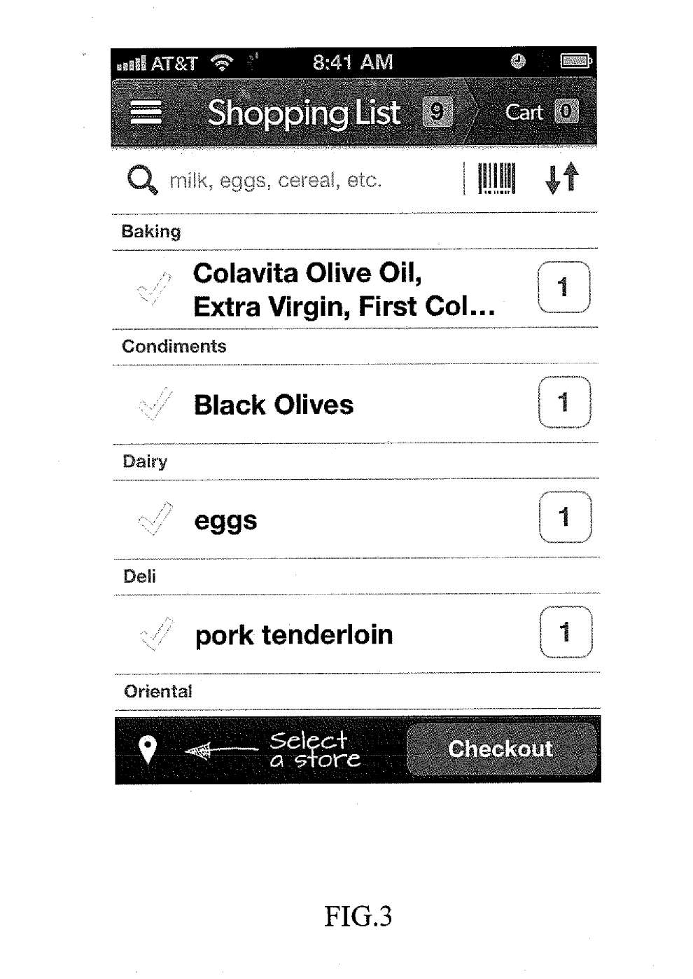

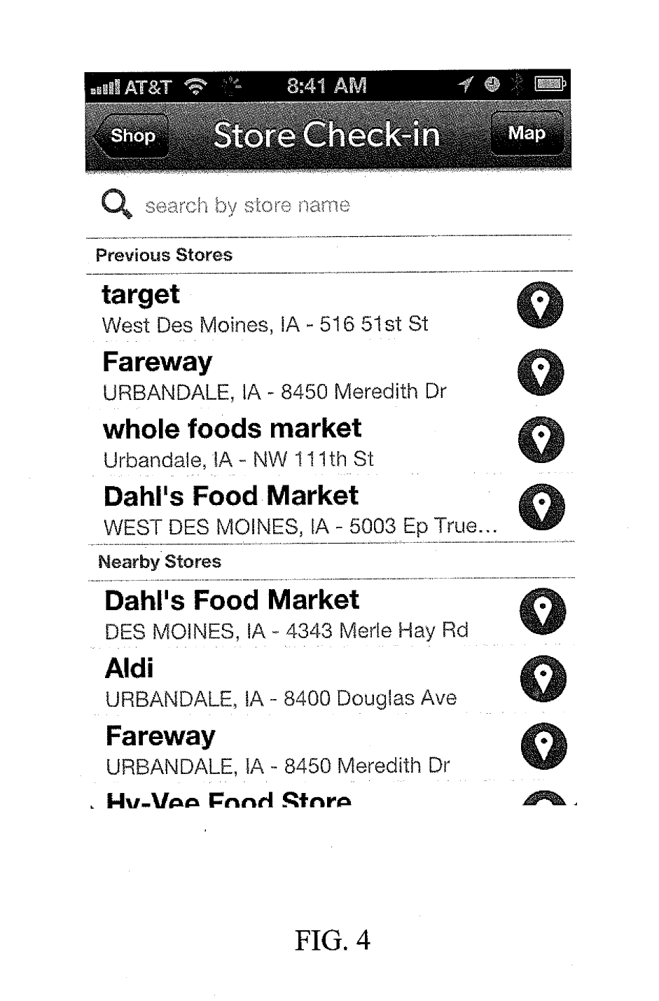

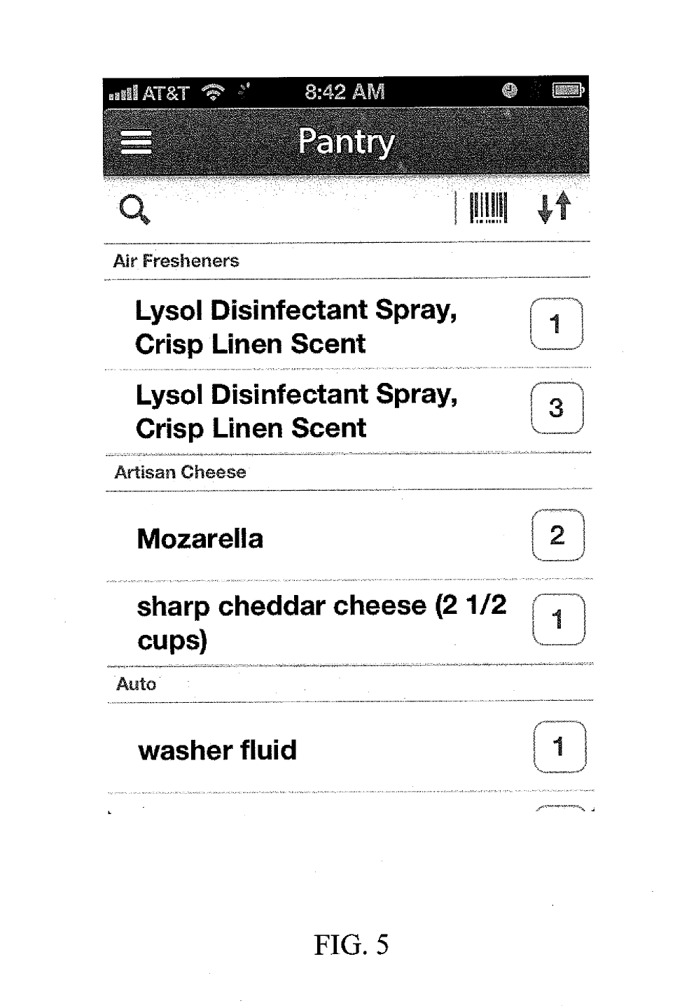

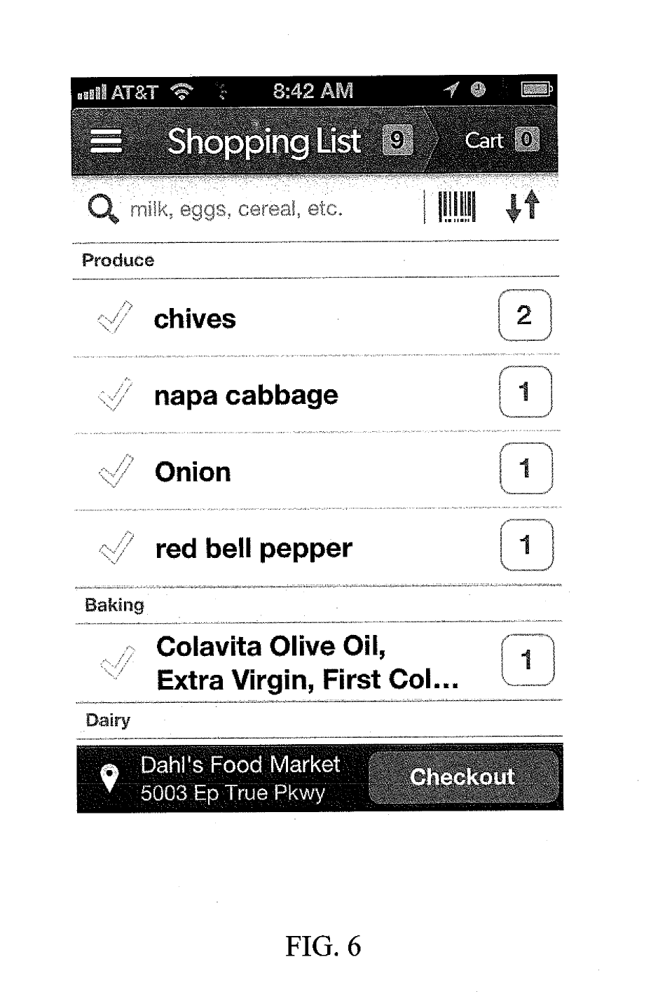

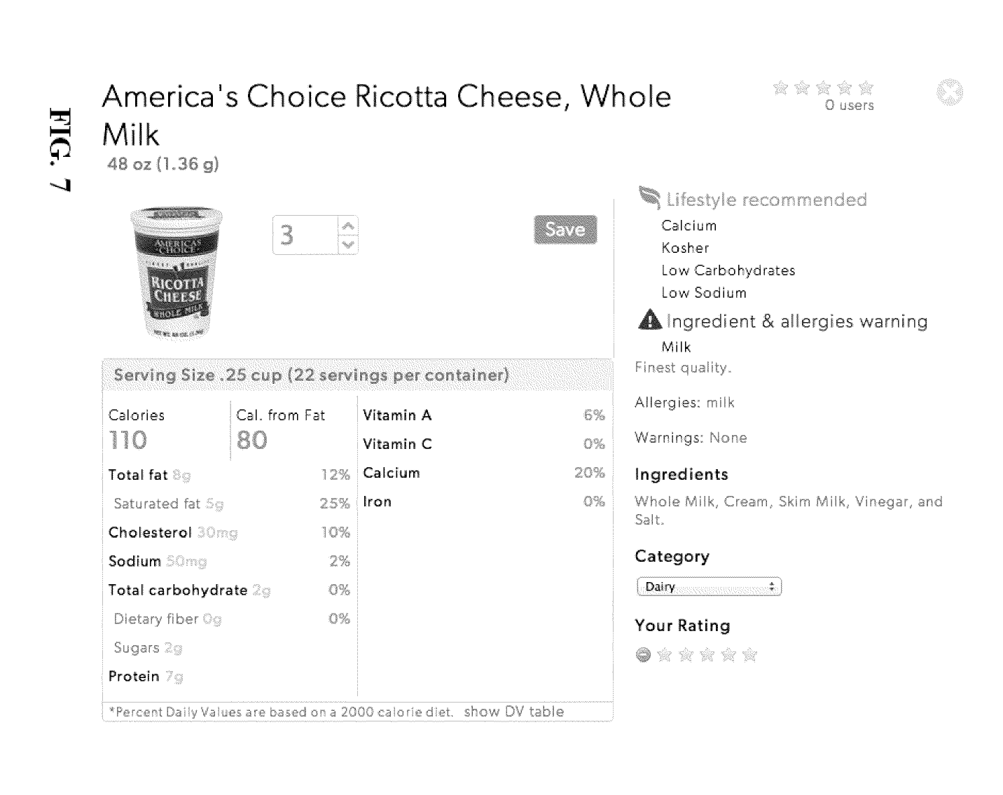

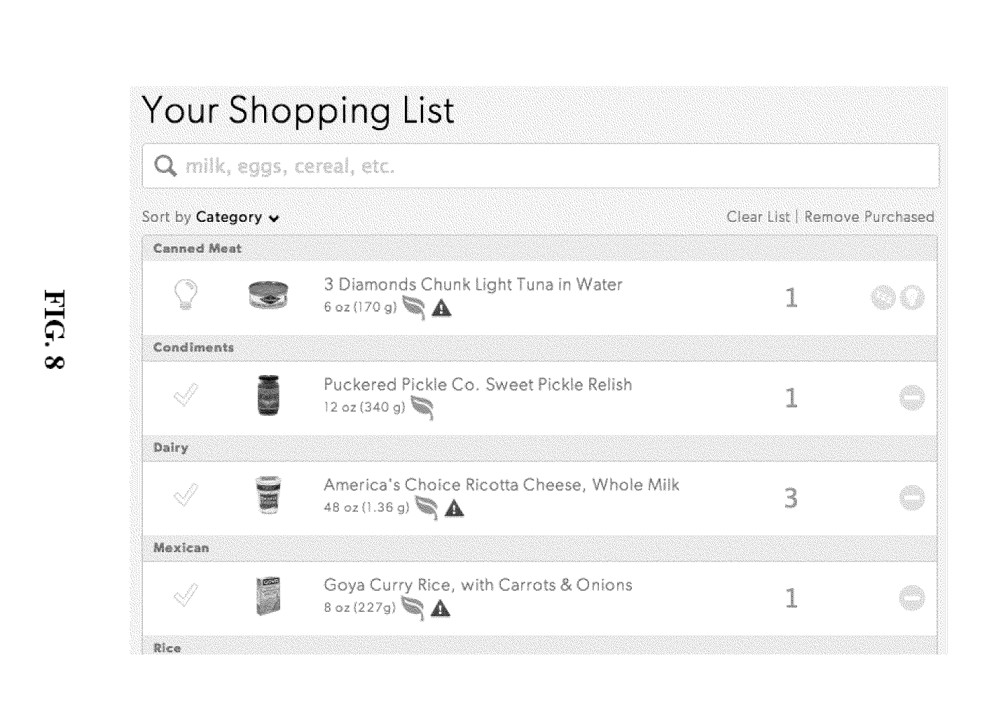

### DETAILED DESCRIPTION OF THE PRESENT INVENTION

The present invention includes a system that arranges a grocery list in accordance with a selection from a list of area stores. Alternatively, the system learns the shopping habits of the user, including the shopper's preferred order of movement through the store and arranges the list accordingly. In a most preferred embodiment, the system combines a given store layout and the shopper's preferred order of movement to create a highly tailored and customized ordered list.

In an embodiment, the invention comprises a system that calculates nutritional intake based on a menu plan and the contents per serving of each particular recipe in the menu plan based on its ingredients and records the same. In one of the embodiments, the system creates a shopping list based on a running inventory and a planned menu. Another embodiment includes a database of nutritional values for hundreds of prepared, ready to eat food items such that these values can be accounted for during menu planning and for recordation of nutritional intake by the user. For example, where the menu includes brand name items such as “Rice Krispies cereal” this embodiment allows the user to determine whether one brand is more desirable than the other based on nutritional profile and select it. Further, the system will “learn” the brand names of food items the shopper purchases and will populate the grocery list with these as opposed to other brand names.

In another embodiment, the system can be set up to generate certain warnings to the shopper. For example, if a menu item is entered along with its recipe, the system may be pre-set by the user to alert for anything on a “warning list” or “lifestyle list” for example peanut allergies, sugar content, or sodium levels or a combination of many other label data. When the grocery list is generated, each item including a characteristic on the warning list will be so indicated so that the shopper is alerted. For another embodiment, the shopper may select “acceptable alternatives” and the system will list alternative items that do not include the warned characteristics. In another embodiment, the shopper may permanently “refuse” the warned item from all future lists.

Preferably, the present invention resides as a mobile application available via mobile telephone or may be resident on another handheld device. In either case, the application may be synced, via cloud or crossload, to another device or devices such as a personal computing device. The system may generate a hard copy shopping list if desired.

Once the shopper has added to or created the list, he selects the store at which he will shop from a short list of area stores. Upon selection of a store from the list, the system will reorganize the list in accordance with the store's layout and organization and the shopper's past shopping patterns at that store. If the store is not present on the list and the user has not used the system at the store in the past, then the user enters the name of the store and indicates he will shop this list at that store. In this manner, the system will become trained by the user in accordance with the store layout and the user's own shopping pattern. Specifically, the user will “mark” each item on the list as he picks the item from the shelf. Alternatively, the store may provide an electronic layout that may be crossloaded to the system; the system then employs the layout and rearranges the list based on generalities it generates from the layout. The shopper then “marks” each item on the list as he picks it from the shelf and the system “learns” the specifics of the store layout and the shopper's patterns and records this information relative to this store on the store list. Next time the shopper can select this store from the store list and the system will rearrange the grocery list in accordance with the past shopping pattern associated with that store list. Again, when shopping, the shopper marks items as he gathers them, and the system continues to learn the patterns and apply them to future shopping trips.

At home, in order to get the most of the inventory management system aspects of the system, the user will “mark” items as he uses them from his pantry. Then, when the shopper starts a new list, the system can automatically populate the new list with these items and the shopper can simply keep or delete, and then add items.

One of the embodiments comprises the following components which may operate via a mobile application, a personal computer device, a handheld device, etc.
Inventory management module; the shopper marks identifiers for items as he uses them, and the system records these and adds them to the next generated list. Marking the item may include selecting from an inventory list or any other action that alerts the system of a change in status of that item relative to its presence or absence in inventory.
Brand and food item database; includes an identifier for each food item in the database, and preferably includes nutritional values for at least some of the food items in the database. In one embodiment the nutritional values are specific to brand name of the item. This database may be associated with the recipe module discussed below, as well as the lifestyle/warning module, and the inventory module.
Recipe module, this module is used by the shopper for entering and storing recipes. The module obtains nutritional values from brand and food item database, and provides the nutritional values to the lifestyle/warning module where the values are analyzed as described below.
Lifestyle or warning module; allows the shopper to enter preferences and/or exclusions related to nutritional values of food items and lifestyle choices. For example, a user of the tool may have an allergy to peanuts. The shopper uses the lifestyle module to set a flag to exclude and substitute or to provide a warning, or both, regarding any food item selected for the list that includes a nutritional value having peanuts as an ingredient. The lifestyle module runs against recipes entered in the recipe module and/or against a current shopping list and generates warnings as set by the user or as determined by the tool. In another embodiment, when the lifestyle module determines a food item either in a recipe or on a shopping list requires a warning, it may select a similar item from the food item database which does not include the warned ingredient as a suggested substitution.
List generator; the generator preferably receives information, directly or indirectly, from the recipe module, lifestyle/warning module, inventory management and, optionally, user input to compile a list of identifiers for food items to be purchased. In some embodiments, the list generator only runs against inventory management. In other embodiments, the list generator simply accepts food item identifiers entered by a user. In still other embodiments, the list generator runs against inventory management, and includes items identified by a user, and may run against the ingredients of a selected recipe or recipes as well as inventory to generate a list.
Stores list; a list of stores for which the tool possesses a layout and/or information related to the shopper's shopping pattern.
Layout module; a store layout includes information pertaining to the locations of various items in a particular store. At its most detailed, the layout may include the location of a particular brand on a shelf; a less detailed embodiment may include general location and side of an aisle in the store for that type of food item e.g. for flour, or for syrup. When present, this module may accept store layouts from another system, for example, uploaded from a site where the user selects the store or stores at which he wishes to shop. Then when the user selects a store from the stores list the system can match the store and the layout for use by the Shopping list organizer described below.
Shopping list organizer; combines information from the list generator, the stores lists, the layout module, and may also include the actual shopping patterns of the shopper as determined from previous shopping trips to that store where the user checked items off of the list as he gathered them. This information is used by the organizer to arrange the order of the items list in a manner that guides the shopper through the store efficiently, selecting items in the order in which the user will pass them as he moves through the store aisles. One embodiment adds a location indicator for each item on the list.

Together, these modules and the tool's functionality provide the shopper with a highly efficient means to generate a shopping list organized in a manner that builds efficiencies into the shopping experience, builds the list according to inventory or selected menu planning, or per user entry or any or all of these mechanisms, and produces a list that is in accordance with the shopper's warning list/criteria. The list will be populated with preferred brands of food items determined from past shopping or as selected. If desired, the shopping tool can be used in conjunction with a nutrition tracking and assessment tool and/or a health coach's or medical advisor's communication tool so that the user's nutritional intake can be simply tracked, recorded and evaluated.

The present invention has been described, including several variations, modifications, and embodiments. The embodiments described above were chosen to enable one of ordinary skill in the art to use the invention sin various embodiments and with various modification as are suited to the particular use contemplated. All such modifications and variations are within the scope of the invention.

What we claim is:

1. A computer enabled shopping list generating system comprising a brand and food item database, a list generator for receiving a plurality of item identifiers each said identifier linked to one of a plurality of food items, and a shopping list organizer and further comprising one or more electronic devices configured to employ the list generator to generate a shopping list and the shopping list organizer to organize said shopping.

2. The system of claim 1 said plurality of item identifiers provided by one or more sources comprising any one or more from a group consisting of: a recipe module, said brand and food item database, and an inventory management module. The system of claim I said one or more sources comprising a recipe module.

3. The system of claim 1 further comprising a lifestyle warning module.

4. The system of claim 1 further comprising a stores list.

5. The system of claim 4 wherein said stores list comprises a store identifier and a store layout for each of a plurality of stores in said list.

6. The system of claim 5 wherein said store layout includes a location identifier for each of a plurality of food items.

7. The system of claim 6 wherein said shopping list organizer retrieves said store layout from said stores list, each said item identifier for said plurality of food items, and each said location identifier for each of said plurality of food items.

8. The system of claim 8 wherein said shopping list organizer reorders the shopping list relative to the location of each of said plurality of food items in said store layout.

9. The system of claim 1 wherein said at least one source comprises at least one from the group consisting of: user input, inventory management module, recipe module.

10. A computer enabled shopping method and list generating system comprising:
a) a list generator for receiving at least one source of a plurality of item identifiers each said identifier linked to a unique food item;
b) means to selectively remove each of said plurality of unique food items as each is acquired;
c) means to select a store from a list;
d) a list organizer for compiling the order of removal of food items from said list and generate a store layout for said store associating each of said plurality of unique food items with a location identifier.

11. The system of claim 10 wherein said system further increases the accuracy of the layout with additional use.

12. A system for generating a shopping list using at least one electronic device said system comprising a plurality of store layouts each associated with a particular store; a list of stores with which a store layout is associated; a plurality of items each item having an identifier; means for loading at least some of said plurality of items and corresponding item identifier in the memory of said electronic device; means for selecting a store from said list; and a shopping list organizer for generating a shopping list organized according to location of each of said plurality of items in the selected store.

13. An electronic system comprising an electronic learning device with access to an electronic physical layout for each of a plurality of stores, said electronic learning device capable of receiving and storing an indicator corresponding to each of a plurality of items and another indicator corresponding to acquisition and locations of each of said items as each said item is acquired.

14. The system of claim 1 further comprising a warning module wherein said system employs the warning module to compare each of said plurality of item identifiers with the brand and food item database and with a list of warnings to generate a list of said food items with which a warning is associated.

15. The system of claim 14 further comprising comparing each item from said list of food items with which a warning is associated to said food item database to generate a substitute or substitutes, thereafter comparing each substitute with the list of warnings to find an acceptable substitute and generating a list of substitute food items not associated with any warning.

16. The method of claim 2 wherein said inventory management module comprises a) an inventory list of a plurality of food items, b) means for removing at least one of said food items from the inventory list, and c) means to generate a list of food items removed from said inventory.

17. The method of claim 16 wherein said one or more electronic devices are configured to cause said list generator to query said inventory management module for said list of food items removed.
